(19) United States
(12) Patent Application Publication
(10) Pub. No.: US 2008/0314814 A1
(43) Pub. Date: Dec. 25, 2008

(54) Filter Element

(75) Inventor: Hubertus Schuett, Sinsheim (DE)

Correspondence Address: ALLEMAN HALL MCCOY RUSSELL & TUTTLE LLP, 806 SW BROADWAY, SUITE 600, PORTLAND, OR, 97205-3335, US

(73) Assignee: JUNKER FILTER GMBH, Sinsheim (DE)

(21) Appl. No.: 12/140,909

(22) Filed: Jun. 17, 2008

(30) Foreign Application Priority Data
Jun. 20, 2007 (DE) 20 2007 008 649.0

(51) Int. Cl. B01D 25/176; B01D 25/32

(52) U.S. Cl. 210/225

(57) ABSTRACT

The present invention relates to a filter element for chamber filters, membrane filters or the like, having a plate-shaped carrier body in which openings are provided for the supply of medium to be filtered as well as for the draining of filtrate, having a flexible filter medium blank and having an installation frame for the releasable attachment of the filter medium blank in a peripheral installation groove provided at the carrier body, with the filter medium blank having an enclosed inflatable hollow body section for the fixing of the filter medium blank in the installation groove at the carrier body.

The invention relates to a filter element for chamber filters, membrane filters or the like in accordance with the preamble of claim 1.

Such a filter element is described in DE-A 16 11 156. It is proposed there to avoid breaks in the flexible filter medium to align the warp and weft of the textile filter medium at an oblique inclination to the edges of the plate-shaped carrier body. The fastening of the filter medium takes place such that its edge is pressed into a groove which is provided parallel to the edge of the carrier body in its end face. The fixing of the edge of the filter medium in this groove takes place by sealing rings. This kind of attachment of the filter medium causes sharp kinks of the filter medium in the region of the groove provided in the carrier body. The filter medium can also only be placed into the groove free of creases with great difficulty. To absorb irregularities such as creases in the edge of the filter medium placed into the assembly groove, the sealing rings serving for its fixing must be made of comparatively soft material.

An arrangement for the fastening of a textile filter medium to a plate-shaped carrier body of a filter element is described in DE-A 15 36 909 in which sharp kinks in the edge sections of the filter medium are avoided. This is done in that the edge of the filter cloth is clamped over a larger surface between the end face of the carrier body and a clamping bar screwed onto it. In this respect, a groove free of undercuts and having soft transitions can additionally be provided in the end face of the carrier body, said groove cooperating with a complementary nose of the clamping bar via a soft intermediate layer. Such a type of fastening is, however, mechanically complex and/or expensive, on the one hand, and also requires greater attention on the fastening of the edges of the filter medium, on the other hand.

A filter element is furthermore disclosed in DE 87 04 934 U1 in which it is proposed for the fastening of a flexible pressing membrane to a plate-shaped carrier body to provide undercut grooves in the end face of the carrier body in which complementary installation bars of the membrane can be latched which are shaped to a thicker edge section of the membrane.

In further filter elements for chamber filters and membrane filters available commercially, the filter medium blanks for the mutually oppositely disposed end faces of the carrier body are guided beyond the carrier body and are there connected to one another by strings, wires, clamps and the like. The attachment of the filter medium blanks is time-intensive. “Cross-filtration” can also occur with this embodiment of the filter element, that is filtrate or liquid containing suspended matter is pressed outwardly in a lateral direction between the plates of the filter press. This is disadvantageous with respect to the clean working of the filter press, but also with respect to filter media which are hazardous to the health.

Such a cross-filtration is eliminated with filter elements likewise commercially available, in that, in them the individual support bodies have a groove which extends directly at the edge for the reception of a round cord seal and a further groove disposed within the first groove for the reception of the edge of the filter cloth. When such round cord seals are used, the diameter of the clamping material must be adapted to the respective thickness of the filter medium to be used from case to case.

The filter medium can furthermore only be installed in an undefined manner with respect to its bias on the carrier body. Premature degradation processes of the filter medium result from this as a consequence of exceeding the permitted force/elongation parameters for the respective filter medium. A change of the originally specified pore size distribution of the filter medium is possible due to an over-elongation of the filter medium, from which, in turn, an impairment of the filtration behavior of the filter medium results. Due to the fact that overhanging fabric of the filter medium is usually thermally cut off, thermal damage to the carrier body (material 90% polypropylene) cannot be precluded with certainty. It is furthermore disadvantageous that no 100% fit in the preset installation groove of the carrier body is ensured by means of this clamping type of the filter medium. Unwanted bacteria growth in the clamping groove must be handled due to the free spaces which form. Finally, the installation of the filter cloth by means of a corresponding round cord is very complex and cost-extensive.

It has already become known from DE 43 25 235 C2 to clamp the filter medium by means of a cast or injection molded cloth clamping section. The installation time can hereby be substantially shortened with respect to the previously named method. It is furthermore ensured that the groove contour of the carrier body is filled completely and that the growth of bacteria and product depositions in the clamping groove of the carrier body are thus avoided. However, phenomena of brittleness and shrinkage can occur based on the chemical or thermal use of the corresponding filter press. On the washing and blowing dry of the product to be filtered, which is necessary for technical method reasons, the filter medium is exposed to extreme strain against the installation direction, whereby the filter medium can jump out of the clamping groove of the carrier body.

It is therefore the object of the present invention to further develop a filter element in accordance with the preamble of claim 1 such that the filter medium blank can be installed simply and is also securely fixed under extreme operating conditions.

This object is satisfied in accordance with the invention by a combination of the features of claim 1.

Accordingly, a filter element for chamber filters, membrane filters or the like is provided, which has a plate-shaped carrier body in which openings are provided for the supply of medium to be filtered and to drain off filtrate. A flexible filter medium blank is fixed in an installation frame for the releasable attachment of this filter medium blank in a peripheral installation groove provided at the carrier body. The filter medium blank has an enclosed inflatable hollow body section for the fixing of the filter medium blank in the installation groove at the carrier body.

The filter medium blank can be installed in a particularly simple manner by this enclosed inflatable hollow body section. It is placed on the carrier body for this purpose, with the integrated hollow space section being inserted into the clamping groove milled in the carrier plate in the non-clamped state. After a corresponding insertion, the hollow section is inflated so that it places itself against the contour of the advantageously undercut groove and thus completely fills the groove. The inflation of the hollow body section advantageously takes place using a gaseous compressible medium, for example air. However, a different medium can also be used to inflate the hollow body section within the framework of the invention. It is important that the stiction lock of the hollow body section in the groove is greater in operation than the counter-pressure by the inflation of the filter medium during the operation of the filter so that a jumping of the hollow body section out of the groove can also be reliably prevented under extreme operating conditions.

Preferred embodiments of the invention result from the dependent claims following on from the main claim.

Accordingly, the hollow body section can be made in the form of a flag, with the flag projecting from the hollow body section forming a seam with which the hollow body section can be connected to the filter medium blank in a simple manner. In this respect, the flag-shaped hollow body section can advantageously be sewn, welded, adhesively bonded, cast or injection molded to the filter medium. Combinations of the connection technologies are also possible.

The hollow body section is advantageously provided with an air supply/venting valve for filling or pressure reduction. Only one valve can also be provided in the manner of a bicycle inner tube.

The hollow body section can consist of a chemical-resistant material such as EPDM (ethylene propylene diene monomer), NBR (nitril butyl rubber), silicone or Viton® (Dupont trademark for fluoroelastomers).

Cut-outs are advantageously provided in the support section and the valves of the hollow body section can be inserted into them. These cut-outs can be covered by means of protective caps for the operation of the filter press.

The installation groove is advantageously of undercut design. The inflated hollow body sections can hereby be fixed particularly well in the installation groove.

The hollow body sections can have different shapes. Their cross-section can, for example, be circular or polygonal or also ellipsoid.

The surface of the hollow body section can preferably have barb-like projections.

Further features, details and advantages of the invention result from the explanations presented with reference to the embodiments and to the drawings, in which the following are shown.

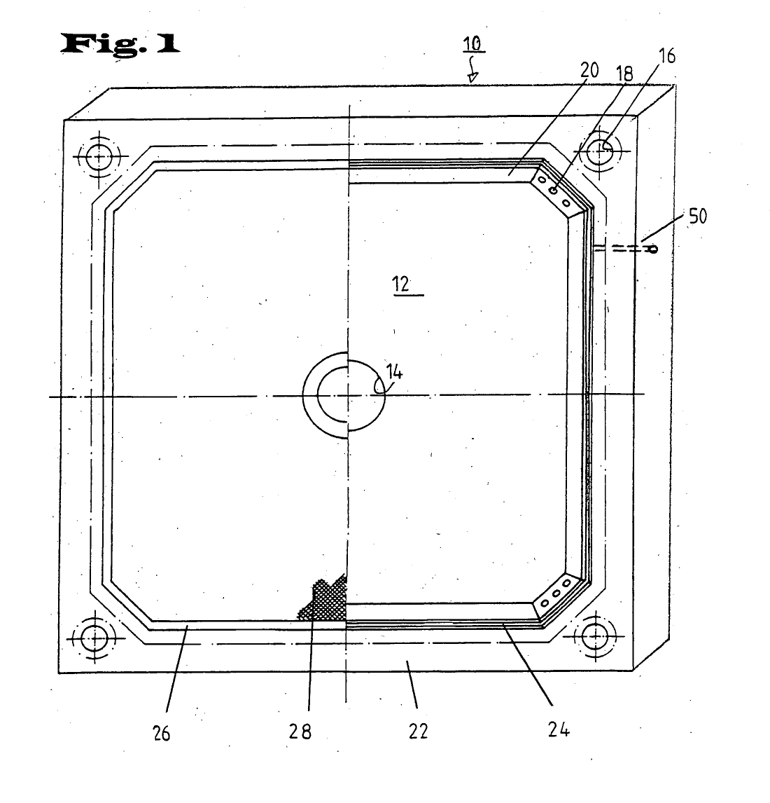

FIG. 1: a view of a filter element in which the filter cloth covering has been removed in the right hand half;

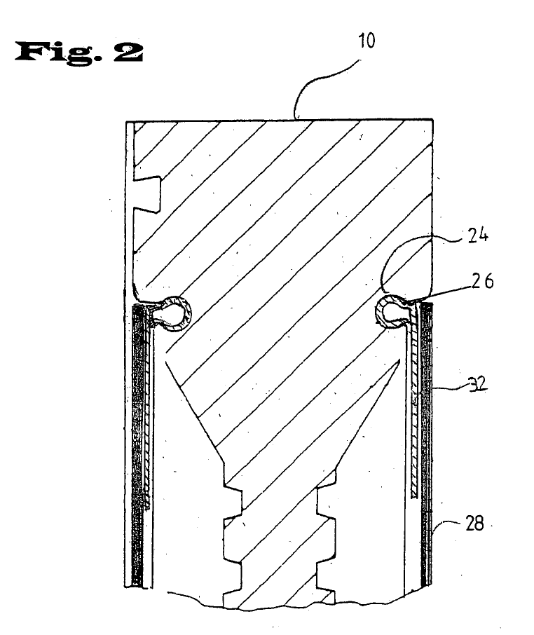

FIG. 2: an enlarged transverse section through an edge region of a carrier plate of the filter element in accordance with FIG. 1; and

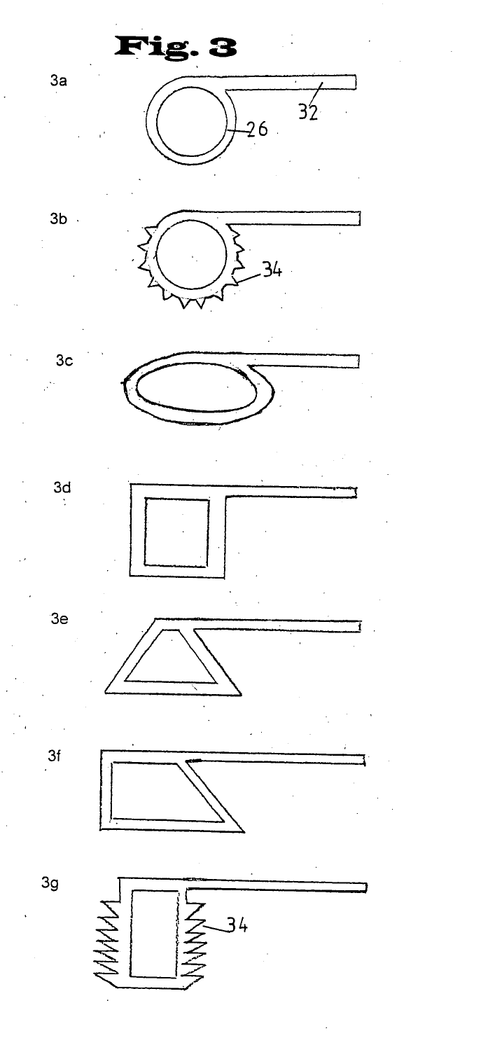

FIG. 3: different embodiments for the cross-section of the hollow body section which is shaped onto the filter cloth blank of the filter element in accordance with FIG. 1.

FIG. 1 shows a carrier plate 10 which is provided with a recess 12 covering its larger part.

A central passage opening 14 serves for the supply of liquid containing solids to be filtered, whereas openings 16 provided in the corner sections of the carrier plate 10 serve for the draining off of filtrate and/or for the supply of washing liquid and/or for the supply of gaseous treatment media such as dry air. The openings 16 communicate, for example, via openings 18 with the recess 12 which are formed in the slantingly sloped edge wall 20 of the recess 12.

An installation groove 24 is provided peripherally parallel to the recess 12 in the edge section 22 of the carrier plate 10 disposed outside the recess 12. A hollow body section 26 which is arranged, for example cast, injection molded, adhesively bonded, welded and/or sewn, at the edge of a filter cloth blank 28 is seated in a shape matched manner in said installation groove. It is important, irrespective of the type of attachment, that the porosity of the filter cloth blank is interrupted at the fastening site so that liquid in the filter cloth cannot migrate outwardly via the fastening site and a cross-filtration can thus be reliably prevented.

FIG. 2 shows details of the fastening of the edge of the filter cloth blank 28 to the carrier plate 10. In the embodiment shown here, the hollow body section 26 is made from a plastic material inflatable by air. Said hollow body section has a flag-shaped projecting seam 32 via which the hollow body section is connected to the filter cloth blank 28 in the manner described in more detail above.

As can furthermore be seen from FIG. 2, the carrier plate 10 is made symmetrical to a center plane so that carrier plates set closely next to one another bound shallow filter chambers which are separated from one another by a filter cloth blank.

To prevent a flat contact of the filter cloth on the base of the recesses 12 on pressure acting on these filter chambers, said recesses are provided with shaped projections 36.

FIG. 3 shows modified cross-sectional shapes of the hollow body sections 26, with the flag-shaped seam regions 32 each being shaped on here. The different cross-sectional shapes are shown in the respective FIGS. 3a to 3g. A circular cross-section thus results here in FIG. 3a; an ellipsoid cross-section in 3c and respective angled cross-sections in FIGS. 3d to 3g, with rectangular, trapezoid or square cross-sections being selected here. Barb-like projections 34 can advantageously be provided which enable an even better connection of the hollow body section 26 inside the groove 24 which has an undercut.

A valve 50 is provided at the hollow body section 26 (see FIG. 1) and is placed into a corresponding cut-out within the carrier plate 10. This cut-out is closed in a manner not shown here.

For installation, the previously described ready-made filter cloth blank 28 is placed onto the carrier plate, with the integrated hollow body section 26 being placed into the clamping groove 24 milled in the carrier plate in the unclamped state.

The integrated valve 50 is introduced into the bore located in the carrier section 10. The hollow space section is inflated by means of a compressed air connection hose (not shown in any more detail here), for example, by means of air at a pressure of approx. 2 bar. Subsequently, the valve is closed by means of a valve cover to protect the system against contamination

The valve 50 of the hollow body section 26 is opened for dismantling. After the air has escaped, the filter medium can simply be removed from the carrier plate 10.

1. A filter element for a filter, comprising:
a plate-shaped carrier body in which openings are provided for supplying medium to be filtered as well as for draining of filtrate,
a flexible filter medium blank and
an installation frame for releasable attachment of the filter medium blank in a peripheral installation groove provided at the carrier body,
wherein the filter medium blank has an inflatable hollow body section closed on itself for fixing the filter medium blank in the installation groove at the carrier body.

2. A filter element in accordance with claim 1, wherein the hollow body section is flag-shaped.

3. A filter element in accordance with claim 2, wherein the flag-shaped hollow body section is sewn, welded, adhesively bonded, cast and/or injection molded to the filter medium.

4. A filter element in accordance with claim 1, wherein an air supply and/or venting valve is arranged at the hollow body section.

5. A filter element in accordance with claim 1, wherein the hollow body section comprises EPDM, NBR, silicone or Viton.

6. A filter element in accordance with claim 1, wherein cut-outs are provided in a support section and the valves of the hollow body section can be inserted into them.

7. A filter element in accordance with claim 1, characterized in that the installation groove is undercut.

8. A filter element in accordance with claim 1, characterized in that the hollow body section is circular in cross-section.

9. A filter element in accordance with claim 1, characterized in that the hollow body section is polygonal in cross-section.

10. A filter element in accordance with claim 1, characterized in that the hollow body section is ellipsoid in cross-section.

11. A filter element in accordance with claim 1, characterized in that barb-like projections are arranged at the surface of the hollow body section.
